(19) United States
(12) Patent Application Publication
(10) Pub. No.: US 2024/0009651 A1
(43) Pub. Date: Jan. 11, 2024

(54) PRE-COATINGS FOR BIOCOMPATIBLE SOLID PHASE MICROEXTRACTION DEVICES

(71) Applicant: SIGMA-ALDRICH CO. LLC, St. Louis, MO (US)

(72) Inventor: Yong Chen, State College, PA (US)

(21) Appl. No.: 18/253,464

(22) PCT Filed: Dec. 2, 2021
(86) PCT No.: PCT/US2021/072707

§ 371 Date: May 18, 2023

Related U.S. Application Data
(60) Provisional application No. 63/121,035, filed on Dec. 3, 2020.
(60) Provisional application No. 63/121,050, filed on Dec. 3, 2020.
(60) Provisional application No. 63/121,071, filed on Dec. 3, 2020.

(51) Int. Cl. B01J 20/32; G01N 30/88

(52) U.S. Cl. CPC B01J 20/321; B01J 20/3217; B01J 20/3223; B01J 20/3236; B01J 20/327; B01J 20/3289; B01J 20/3295; G01N 30/88; B01J 2220/46; G01N 2030/8831

(57) ABSTRACT

An improved device for solid phase microextraction, the device including a plastic substrate, a pre-coating layer on the plastic substrate, and an SPME coating on the precoating layer. SPME coatings are typically incompatible with plastic substrates due to differences between the surface energies of the substrate and the coating, leading to uneven coating and poor adhesion. The addition of the precoating layer provides increased evenness and stronger adhesion of the SPME coating to the plastic substrate. Also provided are method of coating an SPME coating on a plastic substrate, the method including the step of precoating the plastic substrate to provide a precoated substrate and then coating the precoated substrate with an SPME coating, wherein precoating provides improved coating evenness and adhesion of the SPME coating to the plastic substrate.

### CROSS-REFERENCE TO RELATED APPLICATIONS

This application claims the benefit of priority of U.S. Provisional Patent Application Nos. 63/121,050 filed Dec. 3, 2020, 63/121,035 filed Dec. 3, 2020 and 63/121,071 filed Dec. 3, 2020, the entirety of each is incorporated herein by reference.

### BACKGROUND

There is a demand for disposable bio-compatible solid phase microextraction (BioSPME) devices for immersion extraction. To keep costs low, inexpensive materials, like plastics, are preferred. The use of inexpensive plastics, such as polyolefins, however, presents problems when applying the BioSPME extraction phases. Useful extraction phases, such as C18 silica in polyacrylonitrile (PAN), do not adequately adhere to plastic substrates.

The surface energy of plastics is low. For example, the surface energy of polypropylene is about 30 mJ/m². The surface energy of that SPME coating slurries is much higher than that of plastics, which means that the plastic surfaces are not wettable to SPME coating slurries. In other words, SPME coatings can't be evenly coated onto plastic surfaces, and SPME coatings do not adhere to the plastic surface strongly without any pre-treatment of the plastic surfaces.

Traditionally, plastics can be treated with three methods. First, mechanical methods such as sandblasting, tumbling, and abrading with power tools; second, physical methods such as flame, corona discharge, plasma; third, chemical methods such as acid etching, anodization. However, even though the use of these methods can improve the adhesion of coatings to the plastic surface, the adhesion still is not strong, especially in areas such as pointed tips, making these methods inadequate for devices with tips, such as SPME devices.

Accordingly, a need exists for new methods of adhering coatings, such as biocompatible SPME coatings to plastic surfaces. Such methods should be inexpensive, in order to keep the cost of devices low, while yielding strong, even adhesion to the plastic substrate of the device, even along edges or tips.

### SUMMARY

Provided are devices for solid phase microextraction (SPME) having a plastic substrate, a pre-coating layer on the plastic substrate, and an SPME coating on the pre-coating layer.

In one embodiment, the device for SPME includes a plastic substrate having a first surface energy, a pre-coating layer on the plastic substrate, and an SPME coating having a second surface energy on the pre-coating layer, wherein the first surface energy is lower than the second surface energy, the pre-coating layer adheres strongly to the plastic substrate, and the biocompatible coating adheres strongly to the pre-coating layer.

In another embodiment, the device for SPME includes a plurality of plastic pins, a pre-coating layer on the plastic pins, wherein the pre-coating layer is PAN or X18 and optionally includes particles, such as silica, titania, sodium carbonate or polymeric resins, and an SPME coating on the pre-coating layer that includes a binder and a sorbent. In this embodiment, the binder is selected from polyacrylonitrile (PAN), polyethylene glycol (PEG), polypyrrole, derivatized cellulose, polysulfone, polyacrylamide, polyamide, polydimethylsiloxane (PDMS), polyacrylate, polytetrafluoroethylene (PTFE), and polyaniline. The sorbent is selected from functionalized silica, carbon, polymeric resins and combinations thereof.

Also provided is a method for improving the adhesion of an SPME coating on a plastic substrate. The method involves coating a plastic substrate with a pre-coating, then coating the precoated substrate with an SPME coating to provide a device in which the SPME coating adheres to the pre-coated substrate better than it adheres to the untreated plastic substrate. The pre-coating is selected from polyacrylonitrile and X18. In embodiments in which the pre-coating is X18, the pre-coating layer may further include silica or other particles such as titania, sodium carbonate or polymeric resins.

### BRIEF DESCRIPTION OF THE DRAWINGS

FIG. 1A is a microscope image of pin devices coated with a BioSPME coating over an X18:silica pre-coating; FIG. 1B is a microscope image of pin devices coated with a BioSPME coating over a PAN pre-coating.

FIG. 2 is a microscope image showing an uneven coating edge resulting from direct coating of a BioSPME coating on a plastic substrate.

FIG. 3 is a microscope image showing the rough surface produced from conventional pretreatment methods.

FIG. 4A is a microscope image showing weak adhesion of a BioSPME coating at the tips of a pin-shaped substrate from the side; and FIG. 4B shows the same pin-shaped substrate from the edge.

FIG. 5A is a microscope image showing a pre-coating with 7:1 (w/w) ratio of X18:silica; FIG. 5B shows a pre-coating with 5.8:1 (w/w) ratio of X18:silica; FIG. 5C shows a pre-coating with 5:1 (w/w) ratio of X18:silica; and FIG. 5D shows a pre-coating with 3.5:1 (w/w) ratio of X18:silica.

FIG. 6A shows a 16-pin device coated with a X18:silica pre-coating and PAN/C18 BioSPME coating; FIG. 6B shows a 96-pin device coated with a X18:silica pre-coating and PAN/C18 BioSPME coating, and FIG. 6C shows a 384-pin coated with a X18:silica pre-coating and PAN/C18 BioSPME coating.

FIG. 7 shows the percent relative standard deviation for multiple extractions of caffeine, carbamazepine and diazepam at 1000 ng/mL from the same pin multiple times.

FIG. 8 shows the pin-to-pin percent relative standard deviation for extraction of caffeine, carbamazepine and diazepam at 1000 ng/mL from the same device multiple times.

FIG. 9 shows the device-to-device percent relative standard deviation for extraction of caffeine, carbamazepine and diazepam at 1000 ng/mL from the multiple devices.

FIG. 10 is a representative chromatogram for albumin protein, extracted pin, and 2.5 μg/mL standard.

FIG. 11 shows TIC chromatograms of phospholipids in protein precipitated sample, BioSPME extracted sample, and desorption solution. The chromatograms are adjusted to the same relative counts.

FIG. 12 depicts an extraction step (left) removing free analytes from plasma and buffer and the analytes releasing into the desorption solution (right).

FIG. 13 shows a comparison of protein binding values between RED and SPME methods.

FIG. 14 shows representative chromatograms for phospholipids in control sample (acetonitrile protein precipitated) and the BioSPME sample.

### DETAILED DESCRIPTION

The inventor has found that a heretofore incompatible SPME coating may be satisfactorily adhered to a plastic substrate by using a pre-coating to improve the compatibility of the plastic substrate with the SPME coating without the need to use conventional pre-treating methods on the plastic substrate before coating. While the terms SPME and BioSPME are used throughout this specification, the pre-coatings described herein are also useful for other devices, including, for example solid phase extraction (SPE) devices.

As noted earlier, the surface energy of the inexpensive plastics ideally used in producing, for example, multipin SPME devices, is much lower than the surface energy of typical SPME coatings, leading to an incompatibility of the coatings with the substrates, as illustrated in FIG. 2, which illustrates the problem of poor wettability due to the different surface energies. Some approximate surface energies are shown in the table below.

TABLE 1
Surface energies of materials used to prepare SPME devices.

| Material | Surface energy (mJ/m²) |
|---|---|
| Polypropylene (PP): | ~30 |
| Polyacrylonitrile (PAN): | ~39-50 |
| Dimethylformamide (DMF): | ~37 |
| C18 Silica: | ~73 |

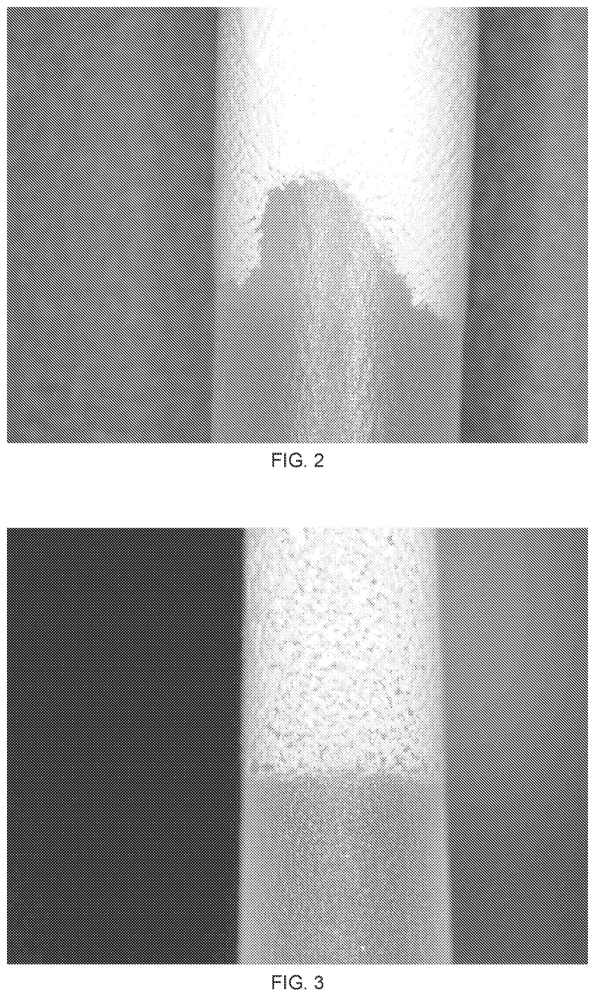

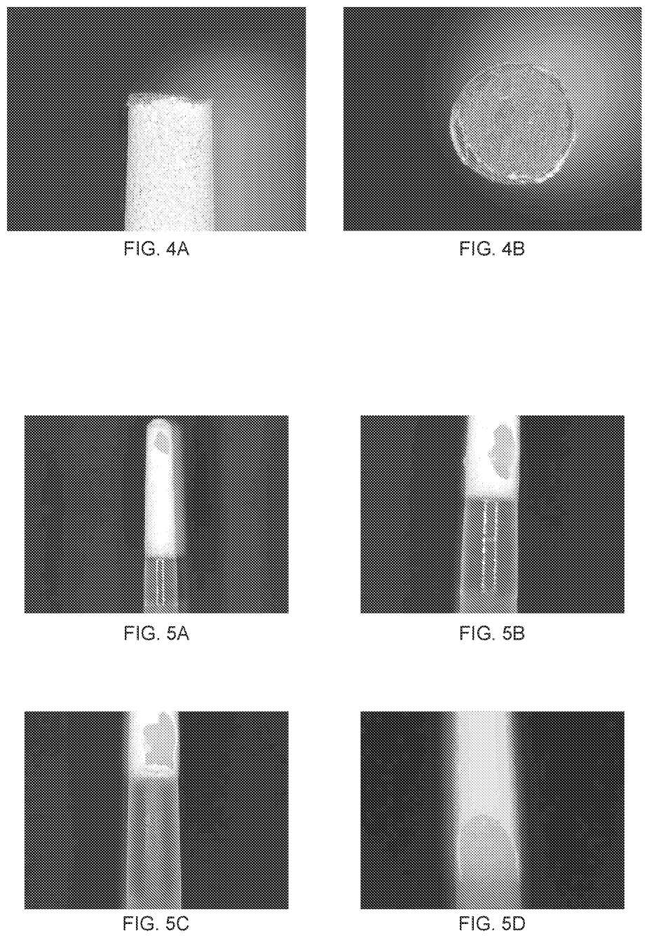

Several conventional methods are known to promote adhesion of coatings to a substrate with a different surface energy. Such methods include mechanical methods, such as sandblasting, tumbling, and abrading with power tools; physical methods, including flame, corona discharge, and plasma; and chemical methods, such as acid etching and anodization. The principle behind these methods is to increase the surface energy and contact area, so that coating slurries can be evenly coated onto plastic surfaces, and the coatings can adhere to the plastic strongly. Such methods, however, produce a rough surface, as shown in FIG. 3, which can result in poor adhesion, as shown in the edges of the pin in FIG. 4.

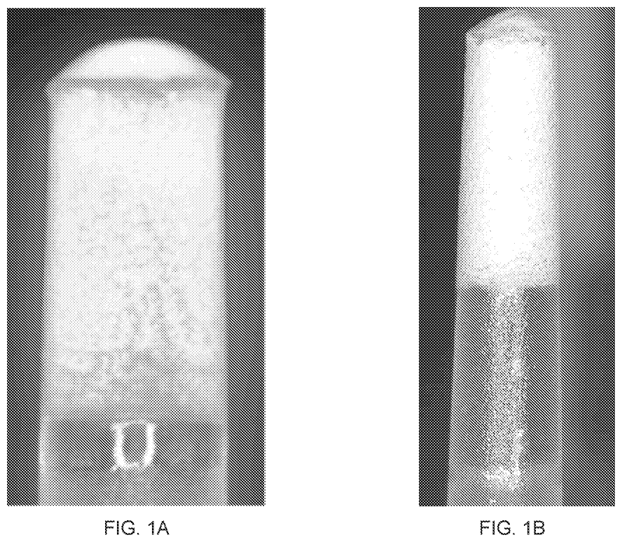

As described herein, it has been found that a new way to promote coating evenness and adhesion is to use a layer of pre-coating or primer on the substrate prior to coating with the SPME coating. The pre-coating acts a buffer between plastic surface and the SPME coating. It adheres strongly to the plastic substrate and provides a surface where top coating, such as an SPME coating can be evenly coated and adhere strongly, as shown in FIG. 1.

The method provided herein allows for coating of a plastic substrate with an SPME coating without the need for any conventional pretreating steps. Some non-limiting examples of suitable plastic substrates include polyolefins, polyamides, polycarbonate, polyester, polyurethanes, polyvinyl chloride, polytetrafluoroethylene (PTFE), polyetheretherketone (PEEK), polysulfone, and polyterephthlate substrates. In some preferred embodiments, the plastic substrate is polypropylene or polyethylene. The pre-coating can be coated directly onto an untreated plastic substrate using the same coating methods as used to apply the SPME or BioSPME coating. When using a BioSPME coating, the pre-coating should improve adhesion of the SPME coating while maintaining the biocompatibility of the SPME coating. That is, the pre-coating must be compatible with biological samples of interest, should not negatively interfere with the adsorptive properties of the SPME coating or otherwise cause interference in sampling or analysis. While the terms SPME and BioSPME are used throughout this specification, the pre-coatings described herein are also useful for other devices, including, for example solid phase extraction (SPE) devices.

The methods described herein are useful for coating any plastic device useful for SPME, including, for example, fibers, blades, tubes, screens or mesh, columns, and pins. As used herein, the term “pin” includes a thin piece of plastic with a tip at one end. Such pins may be cylindrical, rod-like, conical, frustoconical, pyramidal, frustopyramidal, rectangular, square, and so forth. The pins described herein preferably have a solid, closed surface. When the pins are referred to as “solid pins” or as “wherein the pins are solid” means that the surface of the pins is solid. Solid pins, as defined herein, may be differentiated from a design having an opening in the tip, as may be used as a housing for holding an SPE or SPME fiber, wherein the typically metal fiber would be the substrate coated with the SPE or SPME coating. The surface of the pins is coated with the SPME coating. Since only the coated outer surface of the pins comes into contact with a sample, it is not critical whether the inner surface is solid or hollow as neither the coating, nor the sample, contact the inner surface. The tip, or point, of the pin may be flat, rounded, or may come to a point. In some embodiments, the SPME device may include a single pin, while in other embodiments, the device may include a plurality of pins. A particularly preferred pin device is described in copending International Publication No. WO 2019/036414, the entirety of which is incorporated herein by reference.

Preferably, the pins have a diameter in the range from about 0.2 mm to about 5 mm. In preferred embodiments, the diameter of the pins is in the range from about 0.5 mm to about 2 mm. In a particularly preferred embodiment, the pins have a diameter of about 1 mm. The length of the pin can be varied, as for example, to accommodate various sample volumes and well depths. The length of the pins is preferably in the range from about 0.2 mm to about 5 cm. In some embodiments, the length may be from about 0.5 mm to about 2.5 cm. In other embodiments, the length may be from about 1 mm to about 1 cm.

The coatings described herein, the pre-coating and the SPME coating, are applied to the end of the pin that will contact the sample of interest. In some embodiments, approximately half of the length of the pin is coated with the pre-coating and the SPME coating. In other embodiments, approximately one quarter of the length of the pin is coated with the pre-coating and the SPME coating. In various embodiments, the pre-coating and SPME coating may cover a certain portion of the length of the pin or pins, for example, 1/10, ⅕, ¼, ⅓, or ½ of the length of the pin or pins. In other embodiments, the coating may be measured from the tip of the pin, that is, the end of the pin that will contact the sample. In some embodiments, the precoating and coating may cover 1 mm of the pin, in other embodiments, the precoating and coating may cover 1.5 mm, while in other embodiments, the precoating and coating may cover 2 mm of the pin. In an embodiment for a 1 cm pin, the precoating and coating may cover 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm or 5 mm from the end of the pin. In other embodiments, other suitable coatings coverage may readily be determined based on the length, shape and diameter of the pin.

When the device includes more than one pin, e.g., 4 pins, 8 pins, 12 pins, 24 pins, 48 pins, 96 pins, 384 pins or 1536 pins, it is preferred that the coatings cover a similar portion of each pin. In one embodiment, the pins of a multipin device are coated simultaneously using a dip coating process. In such a process, the plastic multipin device is first dipped into the pre-coating, removed, and allowed to dry, and then is dipped in the SPME coating, removed, and dried. Only the portion of the pins to be coated are contacted with the coating preparations or slurries. Such coating methods can ensure consistent coating on all pins in the device. Alternately, other coating methods, such as spray coating, may be used. In both single pin and multipin embodiments, dip coating is the most preferred method of applying the pre-coating and SPME coating layers to the plastic substrate/pins.

In some embodiments, the plastic substrate is untreated when the pre-coating is applied. In a preferred embodiment, the use of the pre-coating provides better adhesion of the SPME coating than when other pretreatment methods, such as mechanical, physical, or chemical methods are used.

In some embodiments, the plastic substrate may be pre-treated using a conventional pre-treatment method prior application of the pre-coating.

The pre-coatings provided herein improve both evenness of the surface and adherence of SPME coatings. Two particularly well-suited pre-coatings include polyacrylonitrile (PAN) and X18, a proprietary, low viscosity, one component primer available from Master Bond, Inc., Hackensack, N.J. 07601. When the pre-coating is X18, silica or other solid particles, such as titania, sodium carbonate, or polymeric resins may be added to the pre-coat slurry to adjust the viscosity and tune the surface properties of the pre-coating. While the addition of silica or other particles is not necessary, it does improve evenness over use of X18 alone. In some embodiments, it is preferred to add silica to X18.

When the pre-coating is PAN, the pre-coating thickness can be in range from 0.5 μm to 200 μm. In some embodiments, the PAN pre-coating thickness may be 0.4 μm, 0.5 μm, 0.6 μm, 0.7 μm, 0.8 μm, 0.9 μm, 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, 10.5 μm, 11 μm, 11.5 μm, 12 μm, 12.5 μm, 13 μm, 13.5 μm, 14 μm, 14.5 μm, 15 μm, 15.5 μm, 16 μm, 16.5 μm, 17 μm, 17.5 μm, 18 μm, 19 μm, 20 μm. In still other embodiments, the PAN pre-coating thickness may be, e.g., 5 μm, 10 μm, 20 μm, 25 μm, 30 μm, 35 μm, 40 μm, 45 pm, or 50 μm. In still other embodiments, the PAN pre-coating thickness may be, e.g., 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm or 200 μm. In a preferred embodiment, the thickness of the PAN pre-coating is in the range from 0.5 μm to 15 μm.

When the pre-coating is X18, the X18 may be used alone or may be combined with particulate SiO₂, TiO₂, Na₂CO₃, solid polymeric resins, or other solid particles. When silica or other particle is added to the X18 pre-coating, the particle size may be in the range from nanoparticles to microparticles. In a preferred embodiment, the particle used in the X18-based pre-coating is silica having a particle size in the range from nanoparticles to 10 μm. The type of silica or other particle, e.g., the porosity, dispersivity, and so on, added to the precoating layer is not of particular importance. Without being bound to theory, the function of the particles in the pre-coating layer is thought to adjust the viscosity of the pre-coating slurry, tune the surface properties of the pre-coating, and aid in improving both evenness of the surface and adhesion of the SPME coating to the substrate. The silica or other particle in the pre-coating is not thought to have any role in the function of the SPME coating.

The X18 to particle ratio is preferred to be larger than 3:1 (w/w). In various embodiments, the ratio of X18 to particles, on a weight/weight basis is in the range from 12:1 to 3:1. In certain embodiments, the ratio of X18:particles (w/w) is from 7:1 to 3:1. In various other embodiments, the ratio of X18 to silica may be (w/w), for example, 11:1, 10.5:1, 10:1, 9.5:1, 9:1, 8.5:1, 8:1, 7.5:1, 7:1, 6.5:1, 6:1, 5.5:1. 5:1, 4.5:1. 4:1, 3.5:1 or 3:1. Preferred ranges of X18:particles (w/w) may include any of these.

In a preferred embodiment, the particle is silica. The X18 to silica ratio is preferred to be larger than 3:1 (w/w). In some embodiments, the ratio of X18 to silica, on a weight/weight basis is 12:1; in various other embodiments, the ratio of X18 to silica may be (w/w), for example, 11:1, 10.5:1, 10:1, 9.5:1, 9:1, 8.5:1, 8:1, 7.5:1, 7:1, 6.5:1, 6:1, 5.5:1. 5:1, 4.5:1. 4:1, 3.5:1 or 3:1. In some embodiments, the ratio of X18 to silica is in the range from 10:1 to 3:1 (w/w). In certain embodiments, the range of range of X18 to silica is from 7:1 to 3.5:1 (w/w). In a preferred embodiment, the ratio of X18 to silica is in the range from 8:1 to 5:1 (w/w).

When a particle, i.e., silica, titania, sodium carbonate or polymeric resin is added to the X18 pre-coating, the pre-coating thickness may be, for example, 0.4 μm, 0.5 μm, 0.6 μm, 0.7 μm, 0.8 μm, 0.9 μm, 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, 10.5 μm, 11 μm, 11.5 μm, 12 μm, 12.5 μm, 13 μm, 13.5 μm, 14 μm, 14.5 μm, 15 μm, 15.5 μm, 16 μm, 16.5 μm, 17 μm, 17.5 μm, 18 μm, 19 μm, or 20 μm. In still other embodiments, the X18 and particle pre-coating thickness may be, e.g., 5 μm, 10 μm, 20 μm, 25 μm, 30 μm, 35 μm, 40 μm, 45 μm, or 50 μm. In still other embodiments, the X18 and particle pre-coating thickness may be, e.g., 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm or 200 μm. In a preferred embodiment, the X18 and particle pre-coating thickness is preferably in the range from 0.5 μm to 15 μm.

An SPME coating is a coating useful for solid phase microextraction applications, typically including a binder and a sorbent. In some applications, the binder and sorbent are biocompatible. By “biocompatible” it is meant that the coating is compatible with biological samples of interest, and biological samples do not negatively interfere with the adsorptive properties of the SPME coating or otherwise cause interference in sampling or analysis.

Some non-limiting examples of binders useful for SPME include polyacrylonitrile (PAN), polyethylene glycol (PEG), polypyrrole, derivatized cellulose, polysulfone, polyacrylamide, polyamide, polydimethylsiloxane (PDMS), polyacrylate, polytetrafluoroethylene (PTFE), and polyaniline. For some applications, the binder should also be biocompatible. Particularly suitable biocompatible binders include polyacrylonitrile (PAN), polyethylene glycol (PEG), polypyrrole, derivatized cellulose, polysulfone, polyacrylamide, and polyamide. In a preferred embodiment, the binder is a biocompatible binder. In a particularly preferred embodiment, the biocompatible binder is PAN.

Sorbents useful in the SPME devices described herein include microspheres such as functionalized silica spheres, functionalized carbon spheres, polymeric resins, mixed-mode resins, and combinations thereof. Typically, microspheres useful for liquid chromatography, i.e., affinity chromatography, as well as those useful for solid phase extraction (SPE) and solid phase micro extraction (SPME) are preferred for the coatings described herein.

In particular, the sorbents may include functionalized silica microspheres, such as, for example, C18 silica (silica particles derivatized with a hydrophobic phase containing octadecyl), C8 silica (silica particles having a bonded phase containing octyl), RP-amide-silica (silica having a bonded phase containing palmitamidopropyl), or HS-F5-silica (silica with a bonded phase containing pentafluorophenyl-propyl).

Some other non-limiting examples of suitable sorbents include: normal-phase silica, C1 silica, C4 silica, C6 silica, C8 silica, C18 silica, C30 silica, phenyl/silica, cyano/silica, diol/silica, ionic liquid/silica, Titan™ silica (MilliporeSigma), molecular imprinted polymer microparticles, hydrophilic-lipophilic-balanced (HLB) microparticles, particularly those disclosed in copending U.S. patent application Ser. No. 16/640,575 published as US 2020/0197907, Carboxen® 1006 (MilliporeSigma), divinylbenzene, styrene, and poly(styrene-co-divinylbenzene). Mixtures of sorbents can also be used in the coatings. The sorbents used in the coatings described herein may be inorganic (e.g. silica), organic (e.g. Carboxen® or divinylbenzene) or inorganic/organic hybrid (e.g. silica and organic polymer). In a preferred embodiment, the sorbent is C18 silica, C8 silica or mixed-mode functionalized silica. In a particularly preferred embodiment, the sorbent is C18 silica.

The sorbent particles, or microspheres, may have diameters in the range from about 10 nm to about 1 mm. In some embodiments, the spherical particles have diameters in the range from about 20 nm to about 125 μm. In certain embodiments, the microspheres have a diameter in the range from about 30 nm to about 85 μm. In some embodiments, the spherical particle has a diameter in the range from about 10 nm to about 10 μm. It is preferable that the spherical particles have a narrow particle size distribution.

In some embodiments, the sorbent particles have a surface area in the range from about 10 m²/g to 1000 m²/g. In some embodiments, the porous spherical particles have a surface area in the range from about 350 m²/g to about 675 m²/g. In some embodiments, the surface area is about 350 m²/g; in other embodiments, the surface area is about 375 m²/g, in other embodiments, the surface area is about 400 m²/g; in other embodiments, the surface area is about 425 m²/g; in other embodiments, the surface area is about 450 m²/g; in other embodiments, the surface area is about 475 m²/g; in other embodiments, the surface area is about 500 m²/g; in other embodiments, the surface area is about 525 m²/g; in other embodiments, the surface area is about 550 m²/g; in other embodiments, the surface area is about 575 m²/g; in other embodiments, the surface area is about 600 m²/g; in other embodiments, the surface area is about 625 m²/g; in other embodiments, the surface area is about 650 m²/g; in still other embodiment, the surface area is about 675 m²/g; and in still other embodiments, the surface area is about 700 m²/g.

Preferably, the sorbent particles used in the devices described herein are porous. In some embodiments, the spherical particles have an average pore diameter in the range from about 50 Å to about 500 Å. In some embodiments, the porosity is in the range from about 100 Å to about 400 Å, in other embodiments, the porosity is in the range from about 75 Å to about 350 Å Moreover, the average pore diameter for the spherical particles used herein may be about 50 Å, about 55 Å, about 60 Å, about 65 Å, about 70 Å, about 75 Å, about 80 Å, about 85 Å, about 90 Å, about 95 Å, about 100 Å, about 105 Å, about 110 Å, about 115 Å, about 120 Å, about 125 Å, about 150 Å, about 160 Å, about 170 Å, about 180 Å, about 190 Å, or about 200 Å.

In preparation for coating, a slurry of sorbent in binder is prepared. The sorbent, binder and a solvent are weighed into a container. If necessary, larger pieces or agglomerates of sorbent are broken down, e.g., with a spatula or mixer. The binder is dissolved in the solvent. Sonication and mixing may also be used to ensure a homogeneous distribution of particles in the binder solution. If desired, the slurry may be degassed prior to coating the substrate.

In a dip coating process, the substrate is lowered into the SPME coating slurry then removed and allowed to dry and cure. In some embodiments, the drying step may be done in air or under nitrogen and may be done at elevated temperatures. In one preferred embodiment, the drying may be done in air or under nitrogen in a temperature and humidity-controlled environment as disclosed in applicant Sigma-Aldrich Co. LLC's copending international patent application entitled “Drying Processes for BioSPME Coatings” filed on Dec. 2, 2021. In another preferred embodiment, the coating may be treated in an immersion precipitation process, as disclosed in applicant Sigma-Aldrich Co. LLC's copending international patent application entitled “Preparation of Solid Phase Microextraction (SPME) Coatings Using Immersion Precipitation” filed on Dec. 2, 2021.

The coating thickness of the SPME coating can be varied to achieve desired properties. In various embodiments, the coating thickness can be in the range from about 0.1 μm to about 200 μm. In preferred embodiments, the coating thickness is in the range from about 2 μm to about 50 μm. In other embodiments, the coating thickness may be, for example, about 1 μm, about 2 μm, about 3 μm, about 4 μm, about 5 μm, about 6 μm, about 7 μm, about 8 μm, about 9 μm, about 10 μm, about 15 μm about 20 μm, about 25 μm, about 30 μm, about 35 μm about 40 μm, about 45 μm, about 50 μm, about 55 μm, about 60 μm, about 65 μm, about 70 μm, about 75 μm, about 80 μm, about 90 μm, about 100 μm, about 110 μm, about 120 μm, about 130 μm, about 140 μm, about 150 μm, about 160 μm, about 170 μm, about 180 μm, about 190 μm, or about 200 μm. In some embodiments, the coating thickness is in the range from about 2 μm to about 50 μm, in other embodiments, the coating thickness is in the range from about 2 μm to about 40 μm, in still other embodiments, the coating thickness is in the range from about 5 μm to about 40 μm, in still other embodiments, the coating thickness is in the range from about 5 microns to about 30 microns, in still other embodiments, the coating thickness is in the range from about 10 microns to about 100 microns. In a preferred embodiment, the coating thickness is in the range from about 10 μm to about 50 μm. The coating thickness can be varied, for example, by performing the coating step multiple times. Thinner coatings, for example, may be used when sample sizes are very small or when fast extraction equilibrium is desired, however, a thinner coating may limit the amount of analyte that may be extracted. For multipin devices it is preferred that the coating thickness is consistent on all pins.

The embodiments described herein are particularly suited for SPME coatings, including biocompatible SPME coatings on plastic substrates. SPME devices may include a single plastic pins, or may include a plurality of plastic pins, such as on devices configured for simultaneous extractions from multiple samples. Such devices are particularly useful in automated sampling systems.

In a first embodiment, the device for solid phase microextraction (SPME) includes a plastic substrate, a pre-coating layer on the plastic substrate, and a SPME coating on the pre-coating layer.

Some non-limited examples of plastic substrates in this embodiment include polyolefin, polyamides, polycarbonate, polyester, polyurethanes, polyvinyl chloride, polytetrafluoroethylene (PTFE), polyetheretherketone (PEEK), polysulfone, and polyterephthalate substrates. In some preferred embodiments, the plastic substrate is polypropylene or polyethylene.

The pre-coating layer in some embodiments includes polyacrylonitrile (PAN). In some embodiments, the pre-coating layer is PAN. When the pre-coating layer includes PAN or when the pre-coating layer is PAN, the thickness of the precoating layer is preferably in the range from 0.5 microns to 200 microns. In some embodiments, the thickness of the precoating layer is in the range from 0.5 microns to 50 microns. In still other embodiments, the thickness of the precoating layer is in the range from 0.5 microns to 20 microns. In a particularly preferred embodiment, the thickness of the precoating layer is in the range from 0.5 microns to 15 microns.

In other embodiments, the pre-coating includes X18. In some embodiments, when the pre-coating layer includes X18, it also includes particles selected from silica, titania, sodium carbonate, polymeric resins or combinations thereof. The particles may be added to the X18 to modify the viscosity of the pre-coating slurry, tune the surface properties of the pre-coating, improve coating evenness, and improve adhesion of the SPME coating to the substrate. The size of the silica or other particles may be in nanoparticle or microparticle range. In preferred embodiments, the silica or other particles have a diameter of 10 microns or less. In some embodiments the pre-coating layer is a combination of X18 and silica. In other embodiments, the pre-coating layer is a combination of X18 and titania, sodium carbonate or polymeric resin. In a preferred embodiment, the precoating layer is X18 and silica. When the precoating layer includes X18 and silica, or when the precoating layer is X18 and silica, the thickness of the precoating layer is preferably in the range from 0.5 microns to 200 microns. In some embodiments, the thickness of the X18 and silica containing precoating layer is in the range from 0.5 microns to 50 microns. In still other embodiments, the thickness of the X18 and silica containing precoating layer is in the range from 0.5 microns to 20 microns. In a particularly preferred embodiment, the thickness of the X18 and silica containing precoating layer is in the range from 0.5 microns to 15 microns.

When the precoating layer includes both X18 and silica, the ratio of X18 to silica, by weight, (X18:silica (w/w)) is preferably greater than 3:1. In some embodiments, the ratio of X18:silica is greater than 5:1 (w/w). In still other embodiments, the ratio of X18:silica is in the range from 10:1 to 3:1 (w/w). In still other embodiments, the ratio of X18:silica is in the range from 8:1 to 5:1 (w/w). It is appreciated that the other particles, such as titania, sodium carbonate, or polymeric resins could be added in the same ratios.

In this first embodiment, the SPME coating, or BioSPME coating includes a binder and a sorbent. Some non-limiting examples of binders useful in this embodiment include polyacrylonitrile (PAN), polyethylene glycol (PEG), polypyrrole, derivatized cellulose, polysulfone, polyacrylamide, polyamide, polydimethylsiloxane (PDMS), polyacrylate, polytetrafluoroethylene (PTFE), polyaniline, and combinations thereof. In a particularly preferred embodiment, the binder is PAN.

The sorbents in this embodiment include any sorbents useful in SPME or BioSPME. Such sorbents include functionalized silica, carbon, polymeric resins and combinations thereof. Many suitable sorbents are discussed above. Some preferred silica sorbents for includes C18 silica, C8 silica, and mixed-mode functionalized silica. Some preferred polymeric resins include HLB resins, divinylbenzene resins, styrene resins, poly(styrene-co-divinylbenzene) resins and combination thereof.

In this first embodiment, the plastic substrate is in the shape of a pin. Preferably, the pin is a solid pin. The length of the pin may be any length suitable for the device. The coatings, that is the pre-coating and the SPME coating are coated on the tip of the substrate, that is the part of the substrate, or the part of the pin, that will contact a sample to be analyzed. In some embodiments, the device includes a plurality of pins, allowing for simultaneous sampling of a number of different samples. Such multipin devices are particularly suited for interface with automated sampling systems.

In a second embodiment, the device for SPME includes a plastic substrate having a first surface energy, a pre-coating layer on the plastic substrate, and an SPME coating having a second surface energy on the precoating layer, wherein the first surface energy is lower than the second surface energy. In this embodiment, the pre-coating layer coats the plastic substrate, thus providing a surface energy more compatible with that of the SPME coating, thereby allowing the SPME coating that is otherwise incompatible with the plastic substrate to be evenly coated on and to strongly adhere to the plastic substrate.

In a preferred embodiment, the plastic substrate is a polyolefin, while in other embodiments, the plastic substrate may polyamide, polycarbonate, polyester, polyurethanes, polyvinyl chloride, polytetrafluoroethylene, polyetheretherketone, polysulfone or polyterephthalate.

In this embodiment, the precoating layer may include PAN or X18. In some embodiments, the precoating layer is PAN or X18. In embodiments in which the pre-coating layer includes X18 or is X18, the pre-coating layer may further include silica. As with the first embodiment, when the precoating layer includes silica, the size of the silica particles may be in nanoparticle or microparticle range. In preferred embodiments, the silica particles have a diameter of 10 microns or less.

Except when the precoating layer is X18 and does not include silica, the thickness of the precoating layer is preferably in the range from 0.5 microns to 200 microns. In some embodiments, the thickness of the precoating layer is in the range from 0.5 microns to 50 microns. In still other embodiments, the thickness of the precoating layer is in the range from 0.5 microns to 20 microns. In a particularly preferred embodiment, the thickness of the precoating layer is in the range from 0.5 microns to 15 microns.

As in previous embodiments, the SPME coating includes a binder and a sorbent. The binder may be selected from polyacrylonitrile (PAN), polyethylene glycol (PEG), polypyrrole, derivatized cellulose, polysulfone, polyacrylamide, polyamide, polydimethylsiloxane, polyacrylate, polytetrafluoroethylene, and polyaniline. The sorbent may be selected from functionalized silica, carbon, polymeric resins and combinations thereof. In a preferred embodiment, the plastic substrate is polypropylene, the binder is PAN and the sorbent is functionalized silica.

A third embodiment provided herein is a device for SPME wherein the device includes a plurality of pins, such as, for example, 4 pins, 8 pins, 12 pins, 24 pins, 48 pins, 96 pins, 384 pins or 1536 pins. The pins of this multipin device may be made of polyolefins, polyamides, polycarbonate, polyester, polyurethanes, polyvinyl chloride, polytetrafluoroethylene, polyetheretherketone, polysulfone and polyterephthalate. In a preferred embodiment, the pins are solid plastic pins. In another preferred embodiment, the pins are solid polypropylene pins.

In this embodiment, each pin in the devices includes a pre-coating laying, the precoating layer includes PAN or X18, and when the precoating includes X18, it may further include a particulate such as silica, titania, sodium carbonate or polymeric resins. In some embodiments, the precoating layer is PAN or X18, optionally including silica. When the precoating includes or is X18 and further includes a particulate such as silica, the size of the silica or other particles may be in nanoparticle or microparticle range. In preferred embodiments, the particles have a diameter of 10 microns or less.

Except when the precoating layer is X18 and does not include silica or other particles, the thickness of the precoating layer is preferably in the range from 0.5 microns to 200 microns. In some embodiments, the thickness of the precoating layer is in the range from 0.5 microns to 50 microns. In still other embodiments, the thickness of the precoating layer is in the range from 0.5 microns to 20 microns. In a particularly preferred embodiment, the thickness of the precoating layer is in the range from 0.5 microns to 15 microns.

The SPME coating, on the precoating layer on each pin, includes a binder and a sorbent. Suitable binders include polyacrylonitrile (PAN), polyethylene glycol (PEG), polypyrrole, derivatized cellulose, polysulfone, polyacrylamide, polyamide, polydimethylsiloxane, polyacrylate, polytetrafluoroethylene, and polyaniline. Suitable sorbents include functionalized silica, carbon, polymeric resins and combinations thereof.

Also provided is a method for improving the adhesion of an SPME coating on a plastic substrate. In accordance with the method, a plastic substrate, such as a pin or plurality of pins, is coated with a pre-coating to provide a precoated substrate, and then coating the precoated substrate with an SPME coating. In accordance with this method, the SPME coating adheres to the precoated substrate better than it adheres to the untreated plastic substrate.

This method is suitable for a variety of plastic substrates useful for SPME, including but not limited to polyolefins, polyamides, polycarbonate, polyester, polyurethanes, polyvinyl chloride, polytetrafluoroethylene, polyetheretherketone, polysulfone and polyterephthalate. In a preferred embodiment, the plastic substrate is a polyolefin, such as polypropylene or polyethylene. In a particularly preferred embodiment, the plastic substrate is a pin or a plurality of pins, such as in a multipin device. In some embodiments, the plastic substrate is used without any pretreatment. In other embodiments, the substrate may be subject to mechanical, physical, or chemical pretreatment prior to the coating with the pre-coating layer.

The precoating according to this method preferably includes polyacrylonitrile (PAN) or X18. In some embodiments, the precoating is PAN or X18. In embodiments in which the precoating layer includes X18, the precoating layer may further include particles, such as silica, titania, sodium carbonate or polymeric resins. When the precoating includes or is X18 and further includes particles, the size of the particles may be in nanoparticle or microparticle range. In preferred embodiments, the particles have a diameter of 10 microns or less.

Except when the precoating layer is X18 and does not include silica or other particles, the thickness of the precoating layer is preferably in the range from 0.5 microns to 200 microns. In some embodiments, the thickness of the precoating layer is in the range from 0.5 microns to 50 microns. In still other embodiments, the thickness of the precoating layer is in the range from 0.5 microns to 20 microns. In a particularly preferred embodiment, the thickness of the precoating layer is in the range from 0.5 microns to 15 microns.

In accordance with this method, the SPME coating includes a binder and a sorbent. Suitable binders for use in this method include polyacrylonitrile (PAN), polyethylene glycol (PEG), polypyrrole, derivatized cellulose, polysulfone, polyacrylamide, polyamide, polydimethylsiloxane, polyacrylate, polytetrafluoroethylene, and polyaniline, and suitable sorbents include functionalized silica, carbon, polymeric resins and combinations thereof.

In a preferred embodiment, the pre-coating is prepared as a slurry and is coated on the plastic substrate by dip coating, then allowed to dry. The SPME coating is also prepared as a slurry. The precoated substrate is then coated with the SPME coating, again by dip coating. In other embodiments, other coating techniques, such as spray coating may be used for either or both of the pre-coating and SPME coating steps. The coated SPME device can then be dried, cured, or otherwise processed in conventional ways.

Pre-coating Procedure for X18 with particles. The particles (silica, titania, sodium carbonate, or polymeric resins) and X18 are weighed into a container and solvent is added. If necessary, such as due to agglomeration of particles, the particles may be broken down with a spatula. The mixture is sonicated for a sufficient time to form a homogeneous slurry. After sonication, the slurry is mixed for an additional time, then degassed in a sonicator and cooled to room temperature. The X18/particle slurry is mixed until ready to use. The substrate is coated by dip coating or other coating method, then allowing the pre-coating to cure. The precoating may be cured by heating, for example, by heating to 110° C. for 1 to 4 minutes, then allowing the coated, cured substrate to cool to room temperature.

Pre-coating for PAN. PAN and a suitable solvent, such as DMF, are weighed into a container. Any larger pieces of PAN may be broken into small pieces using a spatula or mixer. The PAN-solvent mixture is heated to dissolve the PAN. As with the X18/silica pre-coating, the substrate is coated by dip coating or other coating method, then allowing the pre-coating to cure. The precoating may be cured by heating, for example, by heating to 110° C. for 1 to 4 minutes, then allowing the coated, cured substrate to cool to room temperature.

Coating procedure for PAN/C18 BioSPME coating. PAN and a suitable solvent, such as DMF are weighed into a container. Any large pieces of PAN are broken into smaller pieces. The solution is heated to dissolve the PAN. The sorbent is weighed out, added to the PAN solution, and mixed well. The slurry is sonicated to make a homogeneous slurry. The slurry may be degassed and should be mixed until ready to coat. To coat, the pre-coated substrate is dip coated, removed and cured. For comparative examples, the SPME coating is dip coated directly on the plastic substrate.

Coatings are observed visually using a microscope. The ruggedness and adhesion of coatings were tested by (a) by finger rub on the cured coating, and (b) by blue tape adhesion test. The blue tape adhesion test is performed as follows: blue painter's tape (medium adhesion) is applied to the coated, cured SPME device and allowed to stay in place for 90 seconds, the tape is then removed at a 180-degree angle relative to the device. Adhesion is observed visually using a microscope.

The pre-coatings described herein show improved evenness and adhesion of SPME coatings on plastic substrates providing improved results without any loss of biocompatibility. As shown in FIG. 2, a conventional PAN/C18 SPME coated directly onto a plastic pin, via dip coating, resulted in an uneven edge due to poor wettability because of the difference in surface energies between the plastic substrate and the coating. The weak adhesion of the PAN/C18 coating to the plastic substrate with no pre-coating is shown further in FIG. 4, showing both the side and the tip of a coated pin.

Advantageously, the devices provided herein maintain a high level of biocompatibility as will be demonstrated more fully in the examples that follow.

### EXAMPLES

### Example 1

A pre-coating slurry was prepared using of 33 g of X18, 7 g of silica, and 11 g of mesitylene. A conventional PAN/C18 BioSPME coating slurry was prepared. A polypropylene multipin SPME device was coated as follows. A thin layer of pre-coating was formed on the pin by dip coating the pin in the pre-coating slurry and drying at 110° C. for 4 minutes. Upon cooling the pre-coated pin device to room temperature, the PAN/C18 SPME coating was dip coated onto the pre-coated pin tools and dried. A thin layer of uniform of PAN/C18 was formed on the pins.

### Example 2

A PAN pre-coating slurry was preparing by dissolving 5 g of PAN in 35 g of DMF. A conventional PAN/C18 BioSPME coating slurry was prepared. A polypropylene multipin SPME device was coated as follows. A thin layer of pre-coating was formed on the pin by dip coating the pin in the pre-coating slurry and drying at 110° C. for 4 minutes. Upon cooling the pre-coated pin to room temperature, the PAN/C18 SPME coating was dip coated onto the pre-coated pin tools and dried. A thin layer of uniform of PAN/C18 was formed on the pins.

The PAN/C18 SPME coatings in Examples 1 and 2 coated evenly and adhered to the plastic substrate strongly, as shown in FIG. 1.

### Example 3

Comparative example. A polypropylene multipin device was subjected to plasma treatment. (AST Products, Inc., Billerica, Mass.). Contact angle of plasma treated PP: 60-80 (Ref: 90-120). A conventional PAN/C18 SPME coating was dip coated onto the pre-coated pin tools and dried. A thin layer of PAN/C18 was formed on pin. No Significant improvement of PAN/C18 adhesion on PP surface was observed after plasma treatment as compared to untreated PP substrate.

### Example 4

X18:Silica precoating slurries were prepared with ratios of X18:silica of (A) 7:1, (B) 5.8:1, (C) 5:1, and (D) 3.5:1, all (w/w). Images of each are shown in FIG. 5.

### Example 5

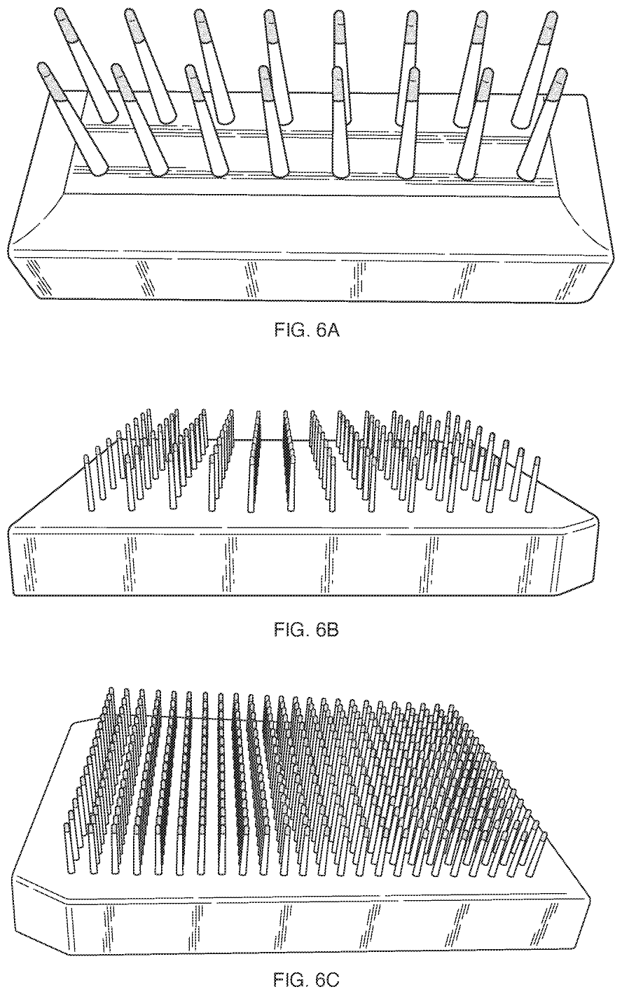

Multipin devices (A) 16-pin, (B) 96-pin, and (C) 384-pin, shown in FIG. 6, were pre-coated with a X18:silica pre-coating and PAN/C18 BioSPME coating.

### Example 6

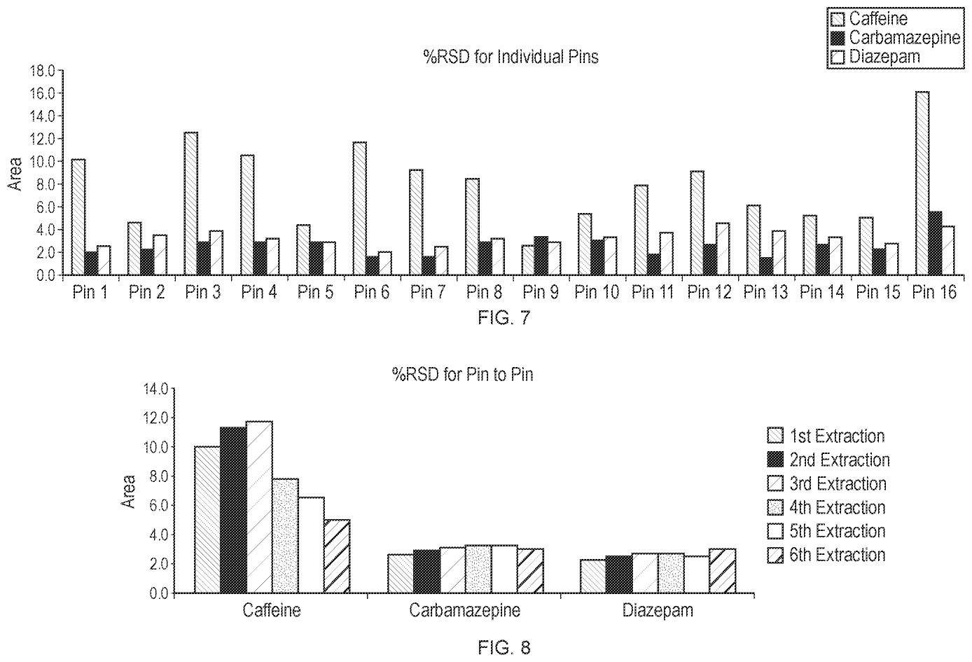

Analytical method validation and device reproducibility. A 16-pin device was prepared with an X18/silica pre-coating and PAN/C18 BioSPME coating. Caffeine, carbamazepine and diazepam at 1000 ng/mL were extracted multiple times per each pin. Individual % RSDs were less than 5% for carbamazepine and diazepam. % RSDs were more variable for caffeine and ranged from 2.7% to 16.3%. The results are shown in FIG. 7.

### Example 7

A 16-pin device was prepared with an X18/silica pre-coating and PAN/C18 BioSPME coating. Caffeine, carbamazepine and diazepam at 1000 ng/mL were extracted from the same device multiple times. % RSDs were less than 5% for carbamazepine and diazepam, and less than 12% for caffeine. The results are shown in FIG. 8.

### Example 8

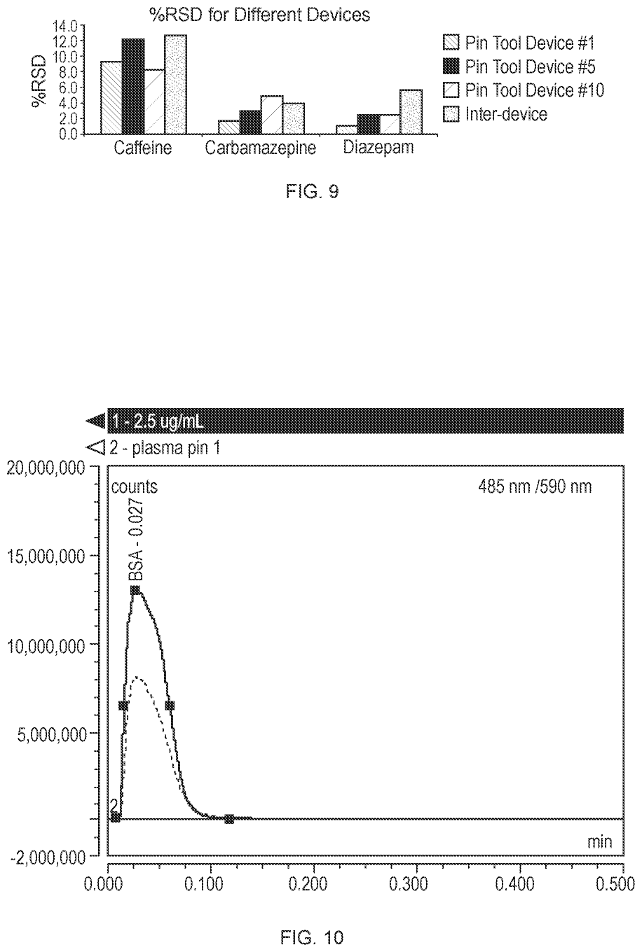

Three multipin devices were prepared with an X18/silica pre-coating and PAN/C18 BioSPME coating. Caffeine, carbamazepine and diazepam at 1000 ng/mL were extracted using multiple devices and the relative standard deviation compared. The percent RSDs were consistent between the three devices and were less than 5% for intra-device precision for carbamazepine and diazepam. Inter-device precision indicated similar % RSDs for caffeine and carbamazepine but were slightly higher for diazepam compared with intra-deice precision. The results are shown in FIG. 9.

### Example 9

Biocompatibility testing. The effectiveness of the pin tool with the pre-coating was examined. A 96-pin device was prepared with an X18/silica pre-coating and PAN/C18 BioSPME coating.

To determine the amounts of phospholipids remaining in sample after extraction using the 96-pin tool, they were compared to phospholipids remaining after acetonitrile assisted protein precipitation. Briefly, the pin tool is conditioned in isopropanol, followed by a short rinse in water. At this point, the pin tool is ready for extraction. After extraction, the pin tool is rinsed briefly to remove any proteins that may remain on the pins' surfaces before the analyte is desorbed and is then ready for analysis.

Protein precipitation was performed by using 100 μL human plasma and mixing with 300 μL of acetonitrile. The mixture was stored at 4° C. for 20 minutes before centrifugation at 5,000 rpm for 10 minutes. The supernatant was transferred and dried at 45° C. under a flow of nitrogen at 10 PSI. The sample was then resuspended in 200 μL of the starting mobile phase.

Five samples from the two methods were analyzed on an AB Sciex-3200 Q Trap mass spectrometry with an Agilent 1290 LC using the method described in Table 2. The phospholipids that were monitored are listed in Table 3.

TABLE 2
LC-MS/MS conditions for monitoring phospholipids

| | |
|---|---|
| Column: | Ascentis ® Express C8 column (10 cm × 2.1 mm, 2.7 mm) |
| Mobile | [A] 5 mM ammonium acetate, 0.1% acetic acid in water |
| Phase: | [B] 5 mM ammonium acetate, 0.1% acetic acid in 95% |
| | acetonitrile and 5% water |
| Gradient: | 80% A, 20% B held for 1.5 min; to 100% B in 1.5 min; the |
| | flow is increased to 0.6 mL/min in 0.1 min and held at |
| | 100% B for 12 min; in 0.1 min the flow is decreased back |
| | to 0.4 ml/min and 20% B, and held for 3 min. |
| Flow Rate: | 0.4 to 0.6 mL/min |
| Column | 40° C. |
| Temp: | |
| Detector: | MS, ESI(+) Scheduled MRM (See Table 1 and 2) |
| Injection: | 2 or 5 μL |

TABLE 3
Phospholipids monitored.

| | | | Dwell Time | | |
|---|---|---|---|---|---|
| Analyte | Precursor | Product | (msec) | DP | CE |
| Choline | 184.1 | 104.1 | 40 | 120 | 80 |
| LPC 16:0 | 496.4 | 184.1 | 40 | 120 | 80 |
| LPC 18:0 | 524.4 | 184.1 | 40 | 120 | 80 |
| PC 30:1 | 704.4 | 184.1 | 40 | 120 | 80 |
| PC 34:2 | 758.4 | 184.1 | 40 | 120 | 80 |
| PC 36:2 | 786.4 | 184.1 | 40 | 120 | 80 |
| PC 38:6 | 806.4 | 184.1 | 40 | 120 | 80 |
| LPC 18:2 | 520.4 | 184.1 | 40 | 120 | 80 |
| LPC 18:1 | 522.4 | 184.1 | 40 | 120 | 80 |
| PC 36:1 | 788.4 | 184.1 | 40 | 120 | 80 |
| PC 38:5 | 804.4 | 184.1 | 40 | 120 | 80 |
| PC 34:1 | 760.4 | 184.1 | 40 | 120 | 80 |
| PC 36:3 | 784.4 | 184.1 | 40 | 120 | 80 |

LPC—lysophosphatidylcholine
PC—phosphatidylcholine

Removal of proteins (albumins). The amount of protein that remain in the extracted sample via non-specific retention on the pins was determined using a NanoOrange™ kit. The pins (eight) were condition for 15 minutes in 800 μL of isopropanol in a well-plate under static conditions. The pins were then washed for 10 seconds in 800 μL of water. Extraction of pooled human plasma (800 μL) took place from a 96-well plate while shaking at 1200 rpm with thermo adapter at 37 ° C. setting. Following extraction, the pins were washed for one-minute in water.

Another well plate was prepared with 1 mL of the working solution (dye for protein staining) loaded into the appropriate wells of a well plate as described in the product directions. The pins used for BSA extraction were exposed to the working solution and allowed to react at 90-96° C. for 10 minutes while shaking at 300 rpm. The well plate was covered with foil to protect the samples from light. The samples were then cooled to room temperature.

The samples were analyzed on a Thermo Scientific Dionex HLPC using fluorescence detector with direct flow (no column), see Table 4. Samples were quantified using the peak height using an external calibration in the range of 0.1-5.0 μg/mL of BSA.

TABLE 4
LC-Fluorescence conditions for monitoring
fluorescent signals from tagged proteins

| | |
|---|---|
| Column: | Direct inject |
| Mobile Phase: | Water, 100% |
| Flow Rate: | 1 mL/min |
| Temp: | 5° C. sample, 30° C. flow cell |
| Detector: | Fluorescence, 485/590 nm |
| Injection: | 50 μL |

Overall Sample cleanliness. The cleanliness of the sample was determined by collecting the TIC of three conditions. These conditions were a control of the 80:20 desorption solution, an extracted spiked plasma sample, and acetonitrile protein precipitate sample.

The acetonitrile precipitated sample was prepared as followed. Leftover spike plasma corresponding to the plasma used in the extracted sample was diluted with 3× with acetonitrile. This sample was then centrifuged for 10 minutes at 10,000 rpm at 4° C. Upon completion, the supernatant was removed and dried under nitrogen at 10 PSI and resuspended in the desorption solution to keep solvent effects to a minimum and better reflect sample cleanliness. All three samples were analyzed as described in Table 2 using a 2 μL injection with a scan of Q1 between 100 to 900 m/z. Multiple methanol injections followed each sample of interest to remove and carry over between samples.

Results. Phospholipid amounts in the BioSPME prepared samples were compared to those of acetonitrile assisted protein precipitation prepared samples. Less than 0.1% of phospholipids remained in the final extracted sample from BioSPME compared to the acetonitrile protein precipitated control. A sample chromatogram comparing the two conditions is shown in FIG. 14.

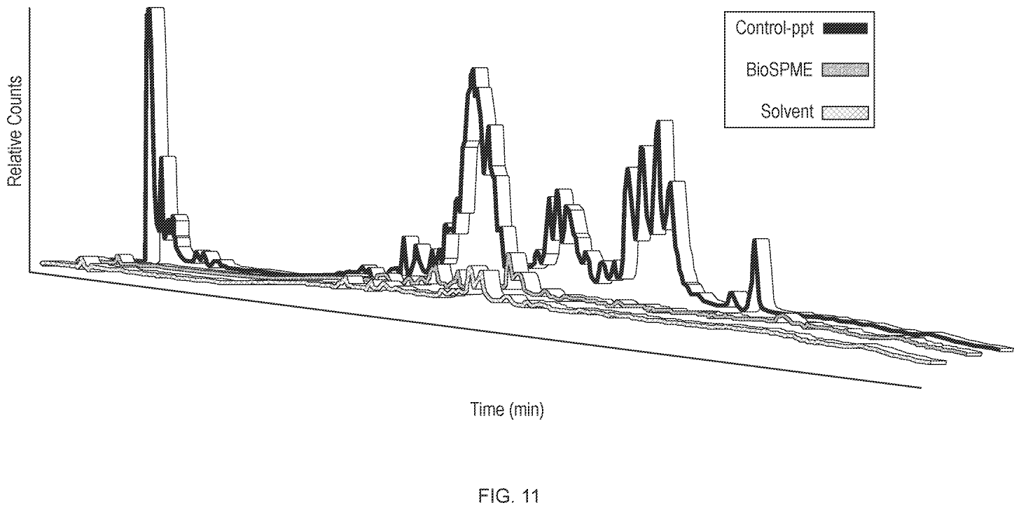

From the NanoOrange™ studies, the pin tools accumulated approximately 1.2 μg of protein, quantified as BSA, on the surface on the pin. A representative chromatogram from a pin compared to a calibrator can be seen in FIG. 10. Albumin accounts for half of the total proteins in plasma (between 35 mg/mL to 50 mg/mL). (Merlot, A., Kalinowski, D., & Richardson, D. (2014). Unraveling the mysteries of serum albumin—more than just a serum protein. Frontier in Physiology, 1-7, https://doi.org/10.3389/fphys.2014.00299.) This value correlates to less than 0.01% of proteins being in the final extracted sample across the eight pins tested.

To show the sample is demonstratively cleaner compared to standard preparation, a full TIC was collected for a protein precipitated plasma sample, BioSPME extracted plasma sample, and desorption solution (see FIG. 11). As seen, the BioSPME extracted sample is significantly closer to the desorption solution than the acetonitrile precipitated sample. The peaks that are observed in the desorption solution corresponds to the deuterated carbamazepine present.

### Example 10

Protein Binding by BioSPME was studied. A 96-pin device was prepared with an X18/silica pre-coating and PAN/C18 BioSPME coating. Human plasma and buffer were spiked at a therapeutically relevant concentration and incubated for one hour at 37° C. while shaking at 300 rpm. After the incubation, 200 μL plasma and buffer were loaded into separate columns on to the extraction well plate (n=8). The determination of the protein binding was determined by automated robotic method using the BioSPME C18 96-pin tool. Briefly, the pin tool is conditioned for twenty minutes static in isopropanol, then it is transferred into a new well plate for 10 seconds in water (wash step). This is followed by the extraction step. The pin tool is transferred into the preloaded extraction plate described earlier. Here, the pin tool extracts the analytes while shaking at 1200-1250 rpm at 37° C. for 15 minutes. The pin tools return to the water solution for a 60 seconds wash and finally transferred into a desorption plate. The desorption solution is a 80:20 methanol:water and desorbs for 20 minutes under static conditions. Samples were analyzed using methods described in Tables 5 and 6.

The extraction plates used in this study included both plastic and glass-coated plates. The choice of the plate depended on the compound properties and how well the compound behaved in buffer solution. More hydrophobic compounds, such as ketoconazole and imipramine were found to exhibit non-specific biding to plastic and had better extraction efficiency from glass-coated 96-well plates. Extraction for erythromycin and propranolol were performed from glass-coated plates as well, as higher extraction efficiency values were obtained from glass in comparison to extraction from plastic plates.

Protein Binding Determination by Rapid Equilibrium Dialysis (RED)

RED was performed as directed by the instruction sheet. Briefly, 200 μL of “spiked” human plasma at a therapeutically relevant concentration and 400 μL of phosphate buffered saline (PBS) were loaded in the corresponding chambers in at least triplicates. The dialysis proceeded for at least 4 hours while covered and shaking at 300 rpm and 37° C. on an Eppendorf shaker. At the end of dialysis, 50 μL of the spiked plasma was mixed with 50 μL of clean (unspiked) PBS and 50 μL of the dialysate (buffer compartment) was mixed with 50 μL of clean plasma. This was achieved to ensure matrix consistency. Next, 300 μL of ice-cold acetonitrile was added to each sample before centrifugation at 5,000 rpm for 10 minutes at 4° C. Finally, the supernatant was transferred into glass vials for analysis by LC-MS/MS as described in Tables 5 and 6 using an AB Sciex 6500 with Agilent 1290 LC using a matrix-matched external calibration in the desorption solution.

TABLE 5
LC-MS/MS Conditions for monitoring analytes
for free fraction determination.

| | |
|---|---|
| Column: | Ascentis ® Express Biphenyl column (10 cm × 2.1 mm, |
| | 2.7 mm) |
| Mobile | [A] 5 mM ammonium acetate, 0.1% acetic acid in 95% |
| Phase: | water and 5% acetonitrile |
| | [B] 5 mM ammonium acetate, 0.1% acetic acid in 95% |
| | acetonitrile and 5% water |
| Gradient: | Initially start at 10% B and hold for 0.5 min, increase to |
| | 90% over 2.5 min, hold at 90% for 2 min, decrease to |
| | 10% in 0.1 min and hold for 2 min at 10% |
| Flow Rate: | 0.4 mL/min |
| Column | 40° C. |
| Temp: | |
| Detector: | MS, ESI(+) Scheduled MRM (See Table 1 and 2) |
| Injection: | Dependent upon analyte; 5-20 μL |

TABLE 6
Analyte description and LC-MS/MS parameters

| | | | | Physiological | Analyte Calibration | | | dwell | | | | |
|---|---|---|---|---|---|---|---|---|---|---|---|---|
| | MW | Log P | pKa | Charge | Curve (ng/mL) | q1 | q3 | (ms) | DP | EP | CE | CXP |
| carbamazepine | 236 | 2.45 | 13.9 | 0 | 0.5-100 | 237.1 | 194.2 | 40 | 21 | 10 | 29 | 26 |
| diazepam | 284.7 | 2.82 | 2.92 | 0 | 1-100 | 285.0 | 193.2 | 40 | 91 | 10 | 43 | 28 |
| imipramine | 280.4 | 4.8 | 9.4 | 1 | 2-100 | 281.1 | 58.2 | 40 | 41 | 10 | 61 | 10 |
| prednisolone | 360.4 | 1.6 | 12.59 | 0 | 5-250 | 361.1 | 147.1 | 50 | 36 | 10 | 33 | 10 |
| propranolol | 259 | 3.48 | 9.42 | 1 | 2.5-100 | 260.2 | 183.1 | 40 | 66 | 10 | 25 | 34 |
| warfarin | 308.3 | 2.6 | 6.33 | −1 | 0.05-10 | 309.1 | 163.0 | 40 | 256 | 10 | 21 | 12 |
| zolpidem | 307.4 | 3.15 | 5.65 | 0 | 0.5-100 | 308.2 | 235.2 | 40 | 36 | 10 | 49 | 16 |
| nalidixic acid | 232.2 | 1.59 | 5.95 | −1 | 1-100 | 233.1 | 187.0 | 25 | 32 | 7.5 | 15.5 | 32 |
| | | | 4.68 | | | | | | | | | |
| erythromycin | 734 | 2.6 | 8.88 | 1 | 0.5-100 | 734 | 576.3 | 40 | 121 | 10 | 27 | 10 |
| Ketoconazole | 530 | 4.35 | 6.75 | 0 | 1-250 | 531.2 | 82.1 | 50 | 51 | 10 | 59 | 10 |
| Buspirone | 385 | 1.78 | 4.12 | 1 | 1-100 | 386.2 | 122.1 | 40 | 51 | 7.5 | 45 | 10 |

Removal of Phospholipids (Matrix Effects)

To determine the amount of phospholipids remaining between the different methods, samples that were processed respectively by either rapid equilibrium dialysis or BioSPME were compared to phospholipids remaining by acetonitrile assisted protein precipitation. Protein precipitation was performed by using 100 μL human plasma and mixing with 300 μL of acetonitrile. The mixture was stored at 4° C. for 20 minutes before centrifugation at 5,000 rpm for 10 minutes. The supernatant was transferred and dried at 45° C. under a flow of nitrogen at 10 PSI. The sample was then resuspended in 200 μL of starting mobile phase.

Five samples from the three methods were analyzed on an AB Sciex-3200 Q Trap mass spectrometry with an Agilent 1290 LC using the method described in Table 7. The phospholipids that were monitored are listed in Table 8.

TABLE 7
LC-MS/MS conditions for monitoring phospholipids

| | |
|---|---|
| Column: | Ascentis ® Express C8 column (10 cm × 2.1 mm, 2.7 mm) |
| Mobile | [A] 5 mM ammonium acetate, 0.1% acetic acid in water |
| Phase: | [B] 5 mM ammonium acetate, 0.1% acetic acid in 95% |
| | acetonitrile and 5% water |
| Gradient: | 80% A, 20% B held for 1.5 min; to 100% B in 1.5 min; the |
| | flow is increased to 0.6 mL/min in 0.1 min and held at |
| | 100% B for 12 min; in 0.1 min the flow is decreased back |
| | to 0.4 ml/min and 20% B, and held for 3 min. |
| Flow Rate: | 0.4 to 0.6 mL/min |
| Column | 40° C. |
| Temp: | |
| Detector: | MS, ESI(+) Scheduled MRM (See Table 1 and 2) |
| Injection: | 2 μL |

TABLE 8
Phospholipids monitored

| | | | Dwell Time | | |
|---|---|---|---|---|---|
| Analyte | Precursor | Product | (msec) | DP | CE |
| Choline | 184.1 | 104.1 | 40 | 120 | 80 |
| LPC 16:0 | 496.4 | 184.1 | 40 | 120 | 80 |
| LPC 18:0 | 524.4 | 184.1 | 40 | 120 | 80 |
| PC 30:1 | 704.4 | 184.1 | 40 | 120 | 80 |
| PC 34:2 | 758.4 | 184.1 | 40 | 120 | 80 |
| PC 36:2 | 786.4 | 184.1 | 40 | 120 | 80 |
| PC 38:6 | 806.4 | 184.1 | 40 | 120 | 80 |
| LPC 18:2 | 520.4 | 184.1 | 40 | 120 | 80 |
| LPC 18:1 | 522.4 | 184.1 | 40 | 120 | 80 |
| PC 36:1 | 788.4 | 184.1 | 40 | 120 | 80 |
| PC 38:5 | 804.4 | 184.1 | 40 | 120 | 80 |
| PC 34:1 | 760.4 | 184.1 | 40 | 120 | 80 |
| PC 36:3 | 784.4 | 184.1 | 40 | 120 | 80 |

LPC—lysophosphatidylcholine
PC—phosphatidylcholine

Determination of % Free Fraction (Fu) by BioSPME

BioSPME method determines the free concentration of analyte in plasma by comparing it with the extraction of the analyte from buffer samples where 100% of the analyte is considered to be free of protein biding.

The percent free or percent unbound is determined in Eq. 1:

$$\begin{matrix}Eq 1. & \\ Free Fraction ( {F}_{U} ) = \frac{concentration free}{concentration total} \times 100 \% & \end{matrix}$$

where concentration free represents the unbound concentration of the analyte in the matrix in this case plasma, and concentration total represents the total concentration of analyte. The amount extracted is independent of units and can be applied using preferred quantities (e.g. nanograms or moles) M_{free}, and extraction volume of plasma, Vₚₗₐₛₘₐ. The concentration of analyte in the desorption solution is quantified by an external calibration curve, and if the desorption volume is equal to the plasma and buffer extraction volumes, the concentration from desorption will be equal to the extracted concentration as shown in Eq 2.

$$\begin{matrix}Eq 2. & \\ concentration extracted from plasma , P = \frac{{M}_{E , Plasma}}{{V}_{plasma}} & \end{matrix}$$

$$\begin{matrix}Eq 3. & \\ concentration extracted from buffer , B = \frac{{M}_{E , Buffer}}{{V}_{Buffer}} & \end{matrix}$$

The bound fraction, F_{B}, can be determined from the extracted concentrations as shown in Eq 6.

$$\begin{matrix}Eq 4. & \\ Bound Fraction ( {F}_{B} ) = 100 \% - Free Fraction ( {F}_{U} ) & \end{matrix}$$

$$\begin{matrix}Eq 5. & \\ Bound Fraction ( {F}_{B} ) = \frac{concentration total - concentration free}{concentration total} \times 100 \% & \end{matrix}$$

$$\begin{matrix}Eq 6. & \\ Bound Fraction ( {F}_{B} ) = \frac{B - P}{B} \times 1 \; 00 \% & \end{matrix}$$

$$\begin{matrix}Eq 7. & \\ Free fraction ( {F}_{U} ) = \frac{P}{B} \times 100 \% & \end{matrix}$$

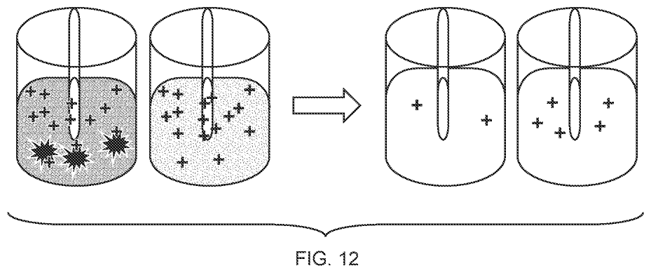

FIG. 12 depicts an extraction step (left) removing free analytes from plasma (pink) and buffer (blue) and the analytes releasing into the desorption solution (right). The amount extracted does not greatly impact the concentration of free analyte which is termed non-depletive. As the buffer solution is considered 100% free, BioSPME will extract more from buffer than from the plasma.

In cases where depletion of compounds from plasma was pronounced upon BioSPME extraction (extraction exceeded 5% of total spiked analyte), a correction to the calculated Bound Fraction was required as described below:

$$Bound Fracion ( {F}_{B} ) = \frac{[ {P}^{0} - \frac{[ ( {B}^{0} - B ) \times P ]}{B} - P ]}{{P}^{0} - P} \qquad Eq . 8$$

where B and P, represent the respective amounts extracted from buffer, B, and plasma, P. B⁰ represents the concentration the samples were spiked originally. Eq 8 accounts for the concentration in solution after extraction on the fiber; the depletion of the analyte from sample.⁶ Eq 6 and Eq 7, do not take this consideration in factor. However, they provide accurate values when the extracted amount is less than 5%.

Comparison of RED Versus BioSPME

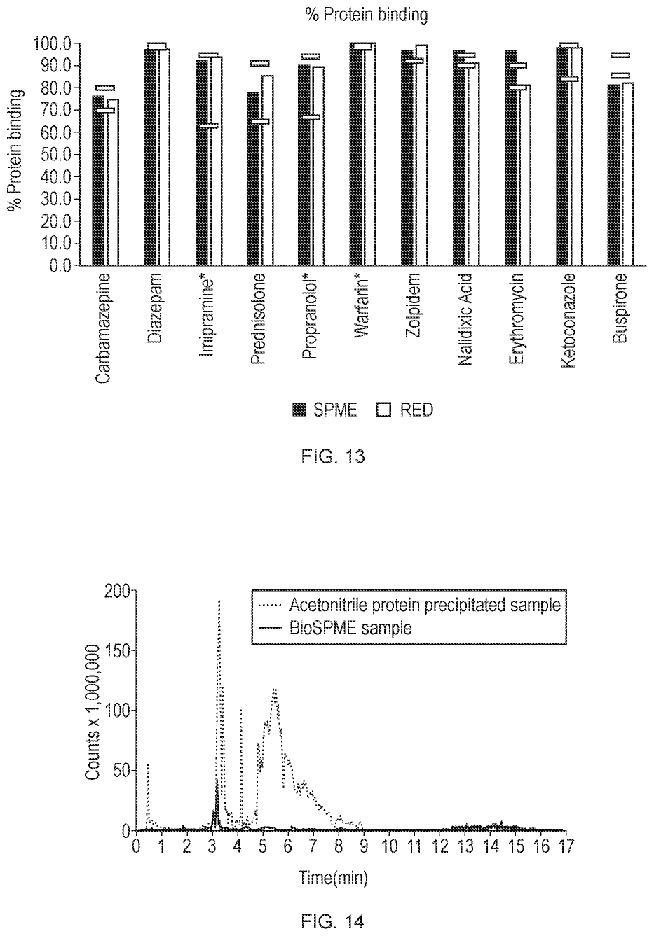

Using the equations, Eq 5 and Eq 6, the values in Table 9 for analyte-protein bindings were determined from BioSPME extractions. These values are in good agreement with values determined using rapid equilibrium dialysis devices (RED) and the reported literature values. These values are compared graphically in FIG. 13.

In addition, Table 10 shows the amount of phospholipid remaining compared to the standard protein precipitation method. A chromatogram of the BioSPME sample versus an acetonitrile protein precipitated sample is shown in FIG. 14. As shown in Table 10, BioSPME removes over 99% of phospholipids in the samples processed. This is in stark contrast to the RED devices which have ˜50% of phospholipids remaining. This amount is deflated from the representative value as it is explained by the dilution of the centrifuged sample with either clean buffer or plasma depending upon the compartment being tested.

The BioSPME technique also provides a timesaving of over 50% as shown in Table 11. The longest step in the BioSPME process is the initial incubation of the analyte with the plasma (60 minutes). This is considerably shorter than the minimum four-hour incubation time required by RED devices.

TABLE 9
Binding Values for the nine compounds from plasma using
BioSPME and 200 μL sample volumes (n = 8).

| | | | | | | Ave. | | Ave. | |
|---|---|---|---|---|---|---|---|---|---|
| | Concentration | | | | | Buffer | Buffer | Plasma | |
| | Spiked | Ave. | RSD | Ave. | RSD | Extracted | RSD | Extracted | Plasma |
| Analyte | (ng/mL) | F_{B(%)} | F_{B(%)} | F_{U(%)} | F_{U(%)} | (ng/mL) | (%) | (ng/mL) | RSD_{(%)} |
| Carbamazepine | 100 | 76.4 | 2.6 | 23.6 | 8.3 | 34.7 | 7.4 | 8.2 | 9.4 |
| Diazepam | 100 | 97.3 | 0.4 | 2.7 | 15.3 | 71.4 | 1.3 | 1.9 | 14.8 |
| Imipramine | 100 | 92.6 | 0.6 | 7.4 | 0.5 | 65.4 | 5.5 | 12.2 | 5.5 |
| prednisolone | 100 | 78.2 | 2.6 | 21.8 | 9.2 | 62.1 | 5.1 | 13.5 | 8.2 |
| Propranolol | 100 | 90.5 | 1.3 | 9.5 | 12.6 | 18.3 | 12.5 | 1.7 | 19.2 |
| Warfarin | 2500 | 99.8 | <0.1 | 0.2 | 8.8 | 10.0 | 6.0 | <0.1 | 22.4 |
| Zolpidem | 100 | 96.9 | 0.4 | 3.1 | 13.7 | 68.4 | 12.0 | 2.1 | 8.5 |
| Nalidixic Acid | 2000 | 97.0 | 0.5 | 3.0 | 15.9 | 16.35 | 14.1 | 0.5 | 14.9 |
| Erythromycin | 100 | 81.8 | 4.2 | 18.2 | 2.8 | 35.0 | 22.4 | 6.5 | 7.8 |
| Ketoconazole | 500 | 96.8 | 0.7 | 3.2 | 0.5 | 282.4 | 5.6 | 20.0 | 7.9 |
| Buspirone | 100 | 81.6 | 1.7 | 18.4 | 7.3 | 47.4 | 6.3 | 14.2 | 6.8 |

FIG. 13 shows a comparison of protein binding values between RED and SPME methods. The blue lines indicate the protein binding literature values interval. Compounds with stars are charged at physiological pH.

TABLE 10
Phospholipid Remaining in analyte by method

| | # of | Average % Phospholipid | |
|---|---|---|---|
| Method | samples | Remaining | RSD |
| BioSPME | 5 | <0.1 | <0.01 |
| Rapid Equilibrium Dialysis | 5 | 56 | 7.8 |

TABLE 11
Comparison of time requirement by method

| | Step Time | | Step Time |
|---|---|---|---|
| RED Method | (min) | BioSPME Method | (Min) |
| Prepare Samples | 5 | Prepare and Incubate | 60 |
| | | Samples | |
| Dialysis | 240 | Condition | 20 |
| Post sample preparation | 5 | Wash | 0.2 |
| Centrifugation | 10 | Extraction | 15 |
| Transfer for into vials for | 5 | Wash | 1 |
| analysis | | | |
| | | Desorption | 15 |
| Total | 265 | Total | 111.2 |

The BioSPME C18 technique offered 50% timesaving for protein binding determination when compared with Rapid Equilibrium Dialysis (RED) method and it was used via fully automated robotic method. BioSPME protein binding values are well compared to these from the Rapid Equilibrium Dialysis method as demonstrated with these 10 compounds with log P's in the range of 1 to 5. In addition, the BioSPME also offers cleaner samples in comparison to those from RED devices.

The examples included herein are for illustrated purposes only and are not meant to limit the scope of the invention as defined by the claims.

The invention claimed is:

1. A device for solid phase microextraction (SPME) comprising
a plastic substrate,
a pre-coating layer on the plastic substrate, and
a SPME coating on the pre-coating layer.

2. The device of claim 1 wherein the plastic substrate is selected from the group consisting of polyolefins, polyamides, polycarbonate, polyester, polyurethanes, polyvinyl chloride, polytetrafluoroethylene (PTFE), polyetheretherketone (PEEK), polysulfone, and polyterephthalate.

3. The device of claim 2 wherein the plastic substrate is selected from the group consisting of polypropylene and polyethylene.

4. The device of claim 1 wherein the pre-coating layer comprises polyacrylonitrile (PAN).

5. The device of claim 1 wherein the pre-coating layer comprises X18 and optionally a particulate selected from the group consisting of silica, titania, sodium carbonate, polymeric resins and combinations thereof.

6. The device of claim 5 wherein the pre-coating layer comprises X18 and particles, particles having a particle size in the range from 1 nanometer to 10 microns, and the range of X18 to particles is from 8:1 to 3:1 (w/w).

7. The device of claim 1 wherein the SPME coating comprises
a binder selected from the group consisting of polyacrylonitrile (PAN), polyethylene glycol (PEG), polypyrrole, derivatized cellulose, polysulfone, polyacrylamide, polyamide, polydimethylsiloxane (PDMS), polyacrylate, polytetrafluoroethylene (PTFE), and polyaniline, and
a sorbent selected from the group consisting of functionalized silica, carbon, polymeric resins and combinations thereof.

8. The device of claim 7 wherein the sorbent is selected from the group consisting of C18 silica, C8 silica, mixed-mode functionalized silica, HLB resins, divinylbenzene resins, styrene resins, poly(styrene-co-divinylbenzene) resins and combination thereof.

9. The device of claim 1, wherein the plastic substrate comprises a pin or a plurality of pins.

10. The device of claim 8, wherein the pin or pins are solid.

11. The device of claim 1, wherein
the plastic substrate has a first surface energy,
the SPME coating has a second surface energy that is higher than the surface energy of the plastic substrate,
wherein the precoating layer adheres strongly to the plastic substrate, and
wherein the SPME coating adheres strongly to the precoating layer.

12. A method for improving the adhesion of an SPME coating on a plastic substrate, the method comprising the steps
providing a plastic substrate,
coating the substrate with a precoat to provide a precoated substrate, and
coating the precoated substrate with an SPME coating,
wherein the precoat is selected from the group consisting of polyacrylonitrile and X18; wherein if the precoating layer is X18, the precoating layer may further include particles selected from silica, titania, sodium carbonate, polymeric resins and combinations thereof, and
wherein the SPME coating adheres to the precoated substrate better than it adheres to the untreated plastic substrate.

13. The method of claim 12 wherein the plastic substrate is selected from the group consisting of polyolefins, polyamides, polycarbonate, polyester, polyurethanes, polyvinyl chloride, polytetrafluoroethylene (PTFE), polyetheretherketone (PEEK), polysulfone and polyterephthalate.

14. The method of claim 12 wherein
the binder is selected from the group consisting of polyacrylonitrile (PAN), polyethylene glycol (PEG), polypyrrole, derivatized cellulose, polysulfone, polyacrylamide, polyamide, polydimethylsiloxane (PDMS), polyacrylate, polytetrafluoroethylene (PTFE), and polyaniline, and
the sorbent is selected from the group consisting of functionalized silica, carbon, polymeric resins and combinations thereof.

15. The method of claim 14, wherein the binder is PAN and the sorbent is C18 functionalized silica.

16. The device of claim 6 wherein the particles are silica particles.

17. A device for solid phase microextraction (SPME) comprising
a plastic substrate comprising a plurality of pins, wherein the pins are solid,
a pre-coating layer on the plastic substrate, and
a SPME coating on the pre-coating layer, wherein
the plastic substrate comprises a plastic selected from the group consisting of polyolefins, polyamides, polycarbonate, polyester, polyurethanes, polyvinyl chloride, polytetrafluoroethylene (PTFE), polyetheretherketone (PEEK), polysulfone, and polyterephthalate,
the pre-coating layer is selected from the group consisting of polyacrylonitrile (PAN), X-18, and a combination of X-18 and particles, wherein the particles are selected from the group consisting of silica, titania, sodium carbonate, and polymeric resins, and
the SPME coating comprises a binder a binder selected from the group consisting of polyacrylonitrile (PAN), polyethylene glycol (PEG), polypyrrole, derivatized cellulose, polysulfone, polyacrylamide, polyamide, polydimethylsiloxane (PDMS), polyacrylate, polytetrafluoroethylene (PTFE), and polyaniline, and a sorbent selected from the group consisting of functionalized silica, carbon, polymeric resins.

18. The device of claim 17 wherein
the plastic substrate is selected from the group consisting of polyethylene and polypropylene,
the pre-coating is PAN, and
the SPME coating comprising PAN and C18 silica.

19. The device of claim 17 wherein
the plastic substrate is selected from the group consisting of polyethylene and polypropylene,
the pre-coating comprises X-18 and silica particles, and
the SPME coating comprising PAN and C18 silica.
